(19) United States
(12) Patent Application Publication
(10) Pub. No.: US 2014/0206820 A1
(43) Pub. Date: Jul. 24, 2014

(54) STYRENE-BASED RESIN BLEND COMPRISING PARTICLES HAVING A TRI-LAYER STRUCTURE AND THE PREPARATION METHOD THEREOF

(71) Applicants: Ming Chen, Beijing (CN); Shuo Wang, Beijing (CN); Huixuan Zhang, Beijing (CN); Shulai Lu, Beijing (CN); Chunyu Zhang, Beijing (CN); Zhichen Cao, Beijing (CN); Jianxun Pang, Beijing (CN)

(72) Inventors: Ming Chen, Beijing (CN); Shuo Wang, Beijing (CN); Huixuan Zhang, Beijing (CN); Shulai Lu, Beijing (CN); Chunyu Zhang, Beijing (CN); Zhichen Cao, Beijing (CN); Jianxun Pang, Beijing (CN)

(73) Assignee: PETROCHINA COMPANY LIMITED, Beijing (CN)

(21) Appl. No.: 14/114,882

(22) PCT Filed: Apr. 13, 2012
(86) PCT No.: PCT/CN2012/000504

§ 371 Date: Mar. 13, 2014

(30) Foreign Application Priority Data
Dec. 28, 2011 (CN) 201110446719.4

(51) Int. Cl. C08F 257/02

(52) U.S. Cl. CPC C08F 257/02
USPC 525/244

(57) ABSTRACT

The present invention relates to a styrene resin blend having three-layer-structured particles, a method for preparing same, and an application thereof. In parts by weight, 100 parts of a vinyl aromatic compound, 0.1 to 10 parts of an initiator, 2 to 10 parts of an emulsifier, 100 to 300 parts of deionized water, and 0.1 to 10 parts of a cross-linking agent are polymerized at a temperature between 50° C. to 85° C. to acquire a core seeded emulsion; 15 to 70 parts of the core seeded emulsion, 0.1 to 10 parts of the initiator, 2 to 10 parts of the emulsifier, 80 to 300 parts of deionized water, and 30 to 85 parts of butadiene or another rubber monomers are reacted to acquire a two-layer particle emulsion; 40 to 90 parts of the two-layer particle emulsion, 10 to 70 parts of monomers of the vinyl aromatic compound, 10 to 60 parts of monomers of a vinyl cyanide compound, 2 to 10 parts of the emulsifier, and 80 to 300 parts of deionized water are reacted to acquire the blend; the impact strength thereof reaches 300 J/m, and the tensile strength is 53 MPa.

### TECHNICAL FIELD OF THE INVENTION

The present invention relates to a styrene-based resin blend having improved impact resistance and high tensile properties. More particularly, the present invention relates to a thermoplastic ABS resin blend primarily comprising ABS-grafted copolymer particles having a tri-layer structure and vinyl cyanide-vinyl aromatic copolymers.

### BACKGROUND OF THE INVENTION

ABS resin is one of the general plastics that are widely used, and is also the rubber toughened plastics that are most widely used. ABS resin is a two-phase polymer blend system, with the continuous phase being SAN matrix and the dispersion phase being ABS grafting copolymer. The method for producing the ABS resin generally used in industry employs seeded emulsion polymerization to synthesize ABS grafting copolymers, which are then melt blended with SAN resin produced by solution polymerization, bulk polymerization or suspension polymerization, so as to obtain product ABS resin. The SAN resin is the matrix phase, whose amount upon blending is generally 70% to 80%. The final properties of the ABS resin are influenced by the molecular weight and branching features of the SAN resin. The amount of the ABS grafting copolymer is about 20% to 30%. The modulus and the amount of the rubber, particle size, molecular weight of the SAN in shell, the grafting density and the like are important factors influencing the mechanical properties and processability of the ABS resin.

In general, ABS grafting copolymer is a two-layer core-shell grafting copolymer having a particle size generally in the range of 100 nm to 400 nm, with polybutadiene as the core, and styrene-acrylonitrile copolymer (SAN) as the shell, which is prepared via emulsion polymerization, for example, those described in CN1803911A, CN100562533C, US2010048798A, US2007142524A etc. However, for conventional ABS grafting copolymer, there is no description on improving the impact resistance and the tensile properties of the ABS resins depending on changing their composition and their structure. Therefore, there is a need for providing a method for preparing new ABS grafting copolymer capable of improving the comprehensive mechanical properties of the ABS resins.

The inventors thus develop an ABS resin having improved impact resistance and tensile strength by synthesizing three-layer-structured ABS grafting copolymers, and then melting blending the ABS grafting copolymers with vinyl cyanide-vinyl aromatic copolymers, which are prepared by solution polymerization, bulk polymerization or suspension polymerization.

### SUMMARY OF THE INVENTION

The subject matter of the present invention is to provide a styrene-based resin blend comprising three-layer structured particles and having good impact resistance and tensile strength, and a method for preparing the same.

The styrene-based resin blend comprising three-layer structured particles according to the present invention comprises vinyl aromatic polymers as a core, polybutadiene or other rubber polymers as an intermediate layer, and a shell on which the molecular chains of vinyl cyanide-vinyl aromatic copolymers are grafted.

The method for preparing the styrene-based resin blend comprising three-layer structured particles according to the present invention comprises the steps and the conditions of:

1) preparation of the core

The core is prepared via emulsion polymerization as follows: 100 parts by weight of vinyl aromatic compound, 0.1 to 10 parts by weight of initiators, 2 to 10 parts by weight of emulsifiers, 100 to 300 parts by weight of deionized water, and 0.1 to 10 parts by weight of cross-linking agent are charged in proportion into the reactor, stirred under nitrogen protection, and polymerized at 50 to 85° C. for 12 to 24 hours, to yield a core seeded emulsion;

the emulsifier is selected from the group consisting of free alkylarylsulfonate, methyl alkali metal sulfate, sulfonated alkyl ester, fatty acid salt, rosin acid alkyl ester and the like, and the compound thereof;

the initiator used is selected from the group consisting of potassium persulfate, benzoyl peroxide, azodiisobutyronitrile and complex initiation system of hydroperoxide diisopropyl benzene-ferrous sulfate and the like;

the crosslinking agent is selected from the group consisting of divinyl benzene and ethylene glycol dimethacrylate;

2) grafting polymerization of the intermediate layer

The intermediate layer is prepared via emulsion grafting polymerization as follows: 15 to 70 parts by weight of the core seeded emulsion, 0.1 to 10 parts by weight of initiators, 2 to 10 parts by weight of emulsifiers, 80 to 300 parts by weight of deionized water, and 30 to 85 parts by weight of butadiene or other rubber monomers are charged in proportion into the reactor and reacted for 4 to 24 hours, to yield a two-layer particle emulsion;

the emulsifier is selected from the group consisting of free alkylarylsulfonate, methyl alkali metal sulfate, sulfonated alkyl ester, fatty acid salt, rosin acid alkyl ester and the like, and the compound thereof;

the initiator used is selected from the group consisting of potassium persulfate, benzoyl peroxide, azodiisobutyronitrile and complex initiation system of hydroperoxide diisopropyl benzene-ferrous sulfate and the like;

3) grafting polymerization of compatilizing segments on the shell

The grafting of the compatilizing segments on the shell is performed via emulsion grafting polymerization as follows: 40 to 90 parts by weight of the two-layer particle emulsion, 10 to 60 parts by weight of vinyl aromatic compound monomer, 10 to 60 parts by weight of vinyl cyanide compound monomer, 0.1 to 10 parts by weight of initiators, 2 to 10 parts by weight of emulsifiers, and 80 to 300 parts by weight of deionized water are charged in proportion into the reactor, and reacted for 2 to 6 hours, and then an antioxidant is added. The mixture is filtered, agglomerated, and dried, to yield ABS grafting copolymer having a three-layer core-shell structure;

the emulsifier is selected from the group consisting of free alkylarylsulfonate, methyl alkali metal sulfate, sulfonated alkyl ester, fatty acid salt, rosin acid alkyl ester and the like, and the compound thereof;

the initiator used is potassium persulfate or complex initiation system of hydroperoxide diisopropyl benzene-ferrous sulfate.

### DETAILED DESCRIPTION OF THE EMBODIMENTS

### Example 1

50 L autoclave equipped with stirrer and condenser is purged with nitrogen gas and kept at a constant temperature of 65° C. 18 kg of deionized water, 0.8 kg of rosin soup, 2 kg of styrene monomer, 0.005 kg of potassium persulfate, 0.02 kg of divinyl benzene are added and polymerized under stirring for 6 hours. Then 14.4 kg of butadiene and 0.036 kg of potassium persulfate are added and polymerized under stirring for another 12 hours. The conversion is 98%, resulting in a two-layer particle emulsion. After completion of the above reaction, 0.0125 kg of potassium persulfate initiator is added, and a blended emulsion of 1.5 kg St monomer and 4.5 kg of AN monomer is added at constant rate in 2 hours. Reaction continues for 1 hour, and an antioxidant is added. After 0.5 hour, the mixture is agglomerated, washed and dried, resulting in ABS grafting powder having three-layer core-shell structure.

80 parts of SAN resin, 2 parts of processing aid, and 20 parts of the ABS grafting powder having three-layer core-shell structure are weighed and sufficiently mixed to be uniformly dispersed, and melt blended at 180° C. in twin-screw extruder, yielding ABS resin granules. A test sample is prepared at 180° C. on injection molding machine. IZOD impact strength of the ABS resin is measured according to ASTM D256 standard. Tensile strength of the ABS resin is measured according to ASTM D638 standard. And the tensile speed is 50 mm/min. Results are presented in Table 1.

### Example 2

50 L autoclave equipped with stirrer and condenser is purged with nitrogen gas and kept at a constant temperature of 65° C. 18 kg of deionized water, 0.8 kg of rosin soup, 3 kg of styrene monomer, 0.0075 kg of potassium persulfate, 0.03 kg of divinyl benzene are added and polymerized under stirring for 6 hours. Then 13.4 kg of butadiene and 0.036 kg of potassium persulfate are added and polymerized under stirring for another 12 hours. The conversion of the reaction is 98%, resulting in two-layer particle emulsion. After completion of the above reaction, 0.0125 kg of potassium persulfate initiator is added, and a blended emulsion of 1.5 kg St monomer and 4.5 kg of AN monomer is added at constant rate in 2 hours. Reaction continues for 1 hour, and an antioxidant is added. After 0.5 hour, the reaction mixture is agglomerated, washed and dried, resulting in ABS grafting powder having three-layer core-shell structure.

80 parts of SAN resin, 2 parts of processing aid, and 20 parts of the ABS grafting powder having three-layer core-shell structure are weighed and sufficiently mixed to be uniformly dispersed, and melt blended at 180° C. in twin-screw extruder, yielding ABS resin granules. The methods for the measurements are the same as those in example 1. The mechanical properties of the ABS resin are presented in Table 1.

### Example 3

50 L autoclave equipped with stirrer and condenser is purged with nitrogen gas and kept at a constant temperature of 65° C. 18 kg of deionized water, 0.8 kg of rosin soup, 4 kg of styrene monomer, 0.01 kg of potassium persulfate, 0.02 kg of divinyl benzene are added and polymerized under stirring for 6 hours. Then 12.4 kg of butadiene and 0.036 kg of potassium persulfate are added and polymerized under stirring for another 12 hours. The conversion is 98%, resulting in a two-layer particle emulsion. After completion of the above reaction, 0.0125 kg of potassium persulfate initiator is added, and a blended emulsion of 1.5 kg St monomer and 4.5 kg of AN monomer is added at constant rate in 2 hours. After addition, the reaction continues for 1 hour, and an antioxidant is added. After 0.5 hour, the reaction mixture is agglomerated, washed and dried, resulting in ABS grafting powder having three-layer core-shell structure.

80 parts of SAN resin, 2 parts of processing aid, and 20 parts of the ABS grafting powder having three-layer core-shell structure are weighed and sufficiently mixed to be uniformly dispersed, and melt blended at 180° C. in twin-screw extruder, yielding ABS resin granules. The methods for the measurements are the same as those in example 1. The mechanical properties of the ABS resin are presented in Table 1.

### Comparative Example 1

50 L autoclave equipped with stirrer and condenser is purged with nitrogen gas and kept at a constant temperature of 65° C. 18 kg of deionized water, 0.8 kg of rosin soup, 14.4 kg of butadiene, 0.036 kg of potassium persulfate are added and polymerized under stirring for 12 hours. The conversion is 98%, resulting in polybutadiene emulsion. After completion of the above reaction, 0.0125 kg of potassium persulfate initiator is further added, and a blended emulsion of 1.5 kg St monomer and 4.5 kg of AN monomer is added at constant rate in 2 hours. After addition, the reaction continues for 1 hour, and an antioxidant is added. After 0.5 hour, the reaction mixture is agglomerated, washed and dried, resulting in conventional ABS grafting powder having two-layer core-shell structure.

80 parts of SAN resin, 2 parts of processing aid, and 20 parts of the ABS grafting powder having two-layer core-shell structure are weighed and sufficiently mixed to be uniformly dispersed, and melt blended at 180° C. in twin-screw extruder, yielding ABS resin granules. The methods for the measurements are the same as those in example 1. The mechanical properties of the ABS resin are presented in Table 1.

### Comparative Example 2

50 L autoclave equipped with stirrer and condenser is purged with nitrogen gas and kept at a constant temperature of 65° C. 18 kg of deionized water, 0.8 kg of rosin soup, 13.4 kg of butadiene, 0.036 kg of potassium persulfate are added and polymerized under stirring for 12 hours. The conversion is 98%, resulting in polybutadiene emulsion. After completion of the above reaction, 0.0125 kg of potassium persulfate initiator is further added, and a blended emulsion of 1.5 kg St monomer and 4.5 kg of AN monomer is added at constant rate in 2 hours. After addition, the reaction continues for 1 hour, and an antioxidant is added. After 0.5 hour, the reaction mixture is agglomerated, washed and dried, resulting in conventional ABS grafting powder having two-layer core-shell structure.

80 parts of SAN resin, 2 parts of processing aid, and 20 parts of the ABS grafting powder having two-layer core-shell structure are weighed and sufficiently mixed to be uniformly dispersed, and melt blended at 180° C. in twin-screw extruder, yielding ABS resin granules. The methods for the measurements are the same as those in example 1. The mechanical properties of the ABS resin are presented in Table 1.

### Comparative Example 3

50 L autoclave equipped with stirrer and condenser is purged with nitrogen gas and kept at a constant temperature of 65° C. 18 kg of deionized water, 0.8 kg of rosin soup, 12.4 kg of butadiene, 0.036 kg of potassium persulfate are added and polymerized under stirring for 12 hours. The conversion is 98%, resulting in a two-layer particle emulsion. After completion of the above reaction, 1.075 kg of potassium persulfate initiator is further added, and a blended emulsion of 1.5 kg St monomer and 4.5 kg of AN monomer is added at constant rate in 2 hours. After addition, the reaction continues for 1 hour, and an antioxidant is added. After 0.5 hour, the reaction mixture is agglomerated, washed and dried, resulting in conventional ABS grafting powder having two-layer core-shell structure.

80 parts of SAN resin, 2 parts of processing aid, and 20 parts of the ABS grafting powder having two-layer core-shell structure are weighed and sufficiently mixed to be uniformly dispersed, and melt blended at 180° C. in twin-screw extruder, yielding ABS resin granules. The methods for the measurements are the same as those in example 1. The mechanical properties of the ABS resin are presented in Table 1.

TABLE 1
Mechanical properties of ABS resins

| | | | | Comparative | Comparative | Comparative |
|---|---|---|---|---|---|---|
| | Example 1 | Example 2 | Example 3 | Example 1 | Example 2 | Example 3 |
| IZOD impact | 290 | 280 | 258 | 180 | 170 | 162 |
| strength, KJ/m² | | | | | | |
| Tensile strength, | 52 | 53 | 53 | 52 | 53 | 52 |
| MPa | | | | | | |
| Flexural strength, | 84 | 84.2 | 84.5 | 82 | 81 | 83 |
| MPa | | | | | | |
| Flexural modulus, | 2765 | 2798 | 2756 | 2715 | 2789 | 2798 |
| MPa | | | | | | |
| Rockwell hardness, | 114 | 114 | 114 | 113 | 114 | 115 |
| R scale | | | | | | |

Measurement temperature: 23 degree

### INDUSTRIAL APPLICABILITY

IZOD impact strength of the ABS resin is measured according to ASTM-D256 standard. The results of the measurement indicate that the impact strength can reach 300 J/m, the sample strip is ductile fractured, and the tensile strength is 53 MPa.

What is claimed is:

1. A method for preparing a styrene-based resin blend comprising three-layer-structured particles, characterized in that:
1) preparation of core
the core is prepared via emulsion polymerization as follows: 100 parts by weight of vinyl aromatic compounds, 0.1 to 10 parts by weight of initiators, 2 to 10 parts by weight of emulsifiers, 100 to 300 parts by weight of deionized water, and 0.1 to 10 parts by weight of cross-linking agent are charged in proportion into the reactor, stirred under nitrogen, and polymerized at a temperature between 50 to 85° C. for 12 to 24 hours, to yield core seeded emulsion;
the emulsifier is selected from the group consisting of free alkylarylsulfonate, methyl alkali metal sulfate, sulfonated alkyl ester, fatty acid salt, abietic acid alkyl ester, and the compound thereof;
the initiator used is selected from the group consisting of potassium persulfate, benzoyl peroxide, azodiisobutyronitrile and complex initiation system of hydroperoxide diisopropyl benzene-ferrous sulfate;
the crosslinking agent is selected from the group consisting of divinyl benzene and ethylene glycol dimethacrylate;
2) grafting polymerization of intermediate layer
the intermediate layer is prepared via emulsion grafting polymerization as follows: 15 to 70 parts by weight of the core seeded emulsion, 0.1 to 10 parts by weight of initiators, 2 to 10 parts by weight of emulsifiers, 80 to 300 parts by weight of deionized water, and 30 to 85 parts by weight of butadiene or other rubber monomers are charged in proportion into the reactor and reacted for 4 to 24 hours, to yield a two-layer particle emulsion;
the emulsifier is selected from the group consisting of free alkylarylsulfonate, methyl alkali metal sulfate, sulfonated alkyl ester, fatty acid salt, abietic acid alkyl ester, and the compound thereof;
the initiator used is selected from the group consisting of potassium persulfate, benzoyl peroxide, azodiisobutyronitrile and complex initiation system of hydroperoxide diisopropyl benzene-ferrous sulfate;
3) grafting polymerization of compatilizing segments on the shell
the grafting of the compatilizing segments on the shell is performed via emulsion grafting polymerization as follows: 40 to 90 parts by weight of the two-layer particle emulsion, 10 to 60 parts by weight of vinyl aromatic compound monomer, 10 to 60 parts by weight of vinyl cyanide compound monomer, 0.1 to 10 parts by weight of initiators, 2 to 10 parts by weight of emulsifiers, and 80 to 300 parts by weight of deionized water are charged in proportion into the reactor, and reacted for 2 to 6 hours, and then an antioxidant is added, and the reaction mixture is filtered, agglomerated, and dried, to yield ABS grafting copolymer having a three-layer core-shell structure;
the emulsifier is selected from the group consisting of free alkylarylsulfonate, methyl alkali metal sulfate, sulfonated alkyl ester, fatty acid salt, abietic acid alkyl ester, and the compound thereof;
the initiator used is potassium persulfate or complex system of hydroperoxide diisopropyl benzene-ferrous sulfate.

2. A styrene-based resin blend comprising a three-layer-structured particles, characterized in that it is prepared by the method according to claim 1.

3. Use of a styrene-based resin blend comprising a three-layer-structured particles, characterized in that the styrene-based resin blend is used for modification of vinyl chloride, polymethyl methacrylate, polyamide, polypropylene, polyester and the mixture thereof.
